(19) United States
(12) Patent Application Publication
(10) Pub. No.: US 2003/0214403 A1
(43) Pub. Date: Nov. 20, 2003

(54) Object Location Indicator System

(75) Inventors: Wing Ho Lam, Vancouver (CA); Jonathan Lap Yan Tsui, Surrey (CA)

Correspondence Address: Wing Ho Lam, 5454 Clarendon Street, Vancouver, BC, V5R3J9, CA

(73) Assignee: Mr. Wing Ho Lam, Vancouver (CA)

(21) Appl. No.: 10/249,865

(22) Filed: May 14, 2003

Related U.S. Application Data
(60) Provisional application No. 60/381,317, filed on May 20, 2002.

(51) Int. Cl. G08B 1/08

(52) U.S. Cl. 340/539.13; 340/573.1

(57) ABSTRACT

The location indicator system includes a base station and a hand-held device. A hand-held device contains directional antennas. Each directional antenna radiates a signal in a particular direction. When the hand-held device is activated, it generates a directional signal, which represents a particular direction, and then the corresponding directional antenna radiates the directional signal respectively. In response, a base station that is located at an object receives the transmitted signals, computes the directional signals to determine its location with respect to the hand-held location, and then it transmits the location information back to the hand-held device. A hand-held device receives the location information and then indicates the location of the object to the users. The location indicator system can be used to determine a location of slow movement or a stationary object, person, and animal. The system is suitable for indoor and outdoor use. It is a cost effective and efficient device.

### BACKGROUND OF INVENTION

1. Field of the Invention

This invention relates to a system and method which determines and indicates the location of an object, person or animal such that the operator is able to easily find an object, person or animal.

2. Background

Searching for missing belongings is a very common daily event. As an example, parents often lose their child in a shopping mall. Another common daily problem is that people forget where their vehicle is parked and wander for a while in a parking lot to locate their vehicle. Searchers are usually worried, frustrated and embarrassed. Therefore, a device that is able to help locating missing belongings is desirable.

Products utilize GPS to indicate location and have been integrated into mobile consumer devices, such as automobile navigation systems. However, an unobstructed view of the sky is necessary when using GPS for precise surveying. The GPS products are not able to locate an object in an indoor environment. Therefore, there is a potential large benefit from the implementation of a mobile system in a way, which allows an operator to find the missing belongings whether in an indoor or outdoor environment.

### SUMMARY OF INVENTION

The present invention comprises a system and method that provides for determining location of an object with respect to the operator location. The system includes a hand-held device that consists of a programmable microprocessor, radio transmitters, radio receiver, directional antennas, and a display module, and a base station mounted in the object consists of omni-directional antenna, radio transmitter, radio receiver, filter circuit and a programmable microprocessor.

The microprocessor included in a hand-held device is used to generate and transmit a directional signal to particular directional antenna. Each of the directional antennas radiates the directional signal in a particular direction. The method of determining a direction of an object is to compute the received directional signals in the base station.

Computing directional signals means for estimating the location of the object with respect to the hand-held device based on the direction information of the signals.

After the approximate location of an object is determined on the base station, the information with regard to the direction of an object is transmitted to the hand-held device. The display module in hand-held device provides the ability to indicate the direction of an object according to the location information sent from the base station.

According to another aspect, this invention provides a base station that is small, light and easy to carry.

These and other features of the present invention can be studied from the following specification, drawings, and brief description.

### BRIEF DESCRIPTION OF DRAWINGS

FIG. 1 is a simplified block diagram of the present invention module circuits, particularly illustrating the major components included in the hand-held device and base station;

FIG. 2 is a block diagram of the present invention system, particularly illustrating the hand-held device transmits directional signals and the base station responses to the incoming signals emitted by a hand-held device;

FIG. 3 is a plot of the horizontal radiation pattern of directional antennas, particularly indicating a directional signal emitted by the hand-held device is radiated in a particular direction and the response signal of the base station;

FIG. 4 is a front perspective view of a hand-held device according to the present invention, particularly showing the system activation push button and the direction indicators on display module; and

FIG. 5 is a decision making flowchart illustrating how the base station can be tracked with a system of FIG. 2 based on the directional signal emitted by the hand-held device according to the present invention.

### DETAILED DESCRIPTION

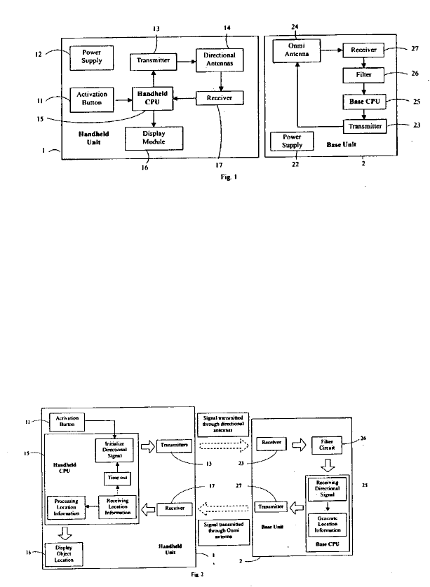

A present invention is a system for tracking object, person or animal. Refer to FIG. 1, which is a simplified block diagram of the present invention module circuits. The system consists of two modules: a hand-held module 1 and a base station 2.

The hand-held device module 1 circuit consists of the following components: an activation button 11, a power supply 12, a programmable microprocessor 15, radio transmitters 13, radio receiver 17, directional antennas 14, and a display module 16. The microprocessor 15 is programmed to perform two functions: 1) to. generate a directional signal which represents a particular direction; and 2) to control the direction indicators 18 on display module 16.

The base station 2 circuit consists of the following components: a power supply 22, a programmable microprocessor 25, a radio transmitter 23, radio receiver 27, filter circuit 26 and an omni-directional antenna 24. The microprocessor 25 is programmed to perform two functions: 1) to determine direction of the object with respect to the operator location by computing the directional signals emitted by hand-held module 1; and 2) to generate the location information that instructs the hand-held module 1 to control the direction indicators 18 on display module 16.

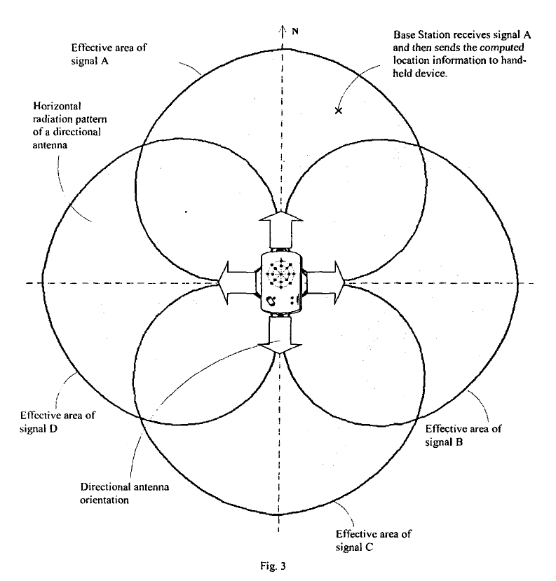

Refer to FIG. 2 which is a block diagram of the present invention system. This system performs finding the location of an object by depressing an activation button marked SEARCH. The activation button 11, once pressed, causes the microprocessor 15 to generate and transmit a directional signal, which presents a particular direction. Radio transmitters 13 amplifier the directional signal and send the signal to corresponding direction antennas 14. The directional antennas 14 radiate the corresponding directional signal in a particular direction, covering the area where the base station 2 is located.

In response, a base station 2 that is mounted in an object receives the directional signals emitted by hand-held device 1. A microprocessor 25 computes the location of the object according to the decision making chart shown in FIG. 5. Once the location of the object is determined, the microprocessor 25 generates and transmits a location information signal, causing direction indicators 18 on display module 16 to light up in the direction of the object. A filter circuit 26 performs filtering reflected and refracted signals and the signal noise.

Refer to FIG. 3 which is a representation of a 90-degree sector directional antenna 14 mounted internally on each side of hand-held device 1. Each of the directional antennas 14 radiates the corresponding directional signal in a particular direction, covering the area where the base station 2 is located. A base station 2 determines the location information based on the received directional signals.

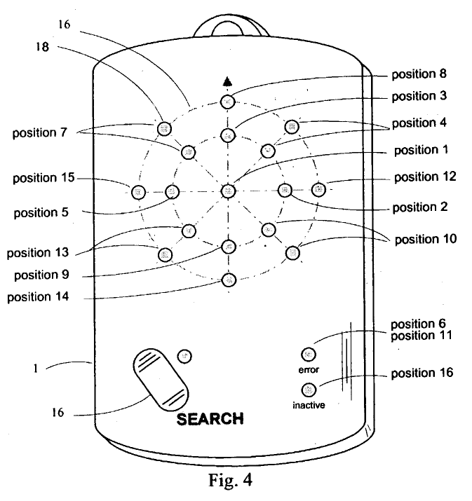

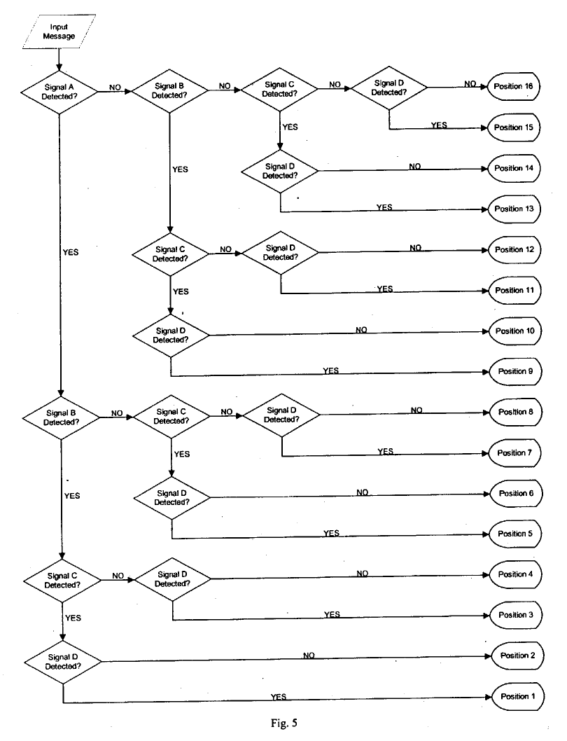

Refer to FIG. 4 which is a front perspective view of the present invention hand-held device 1. The hand-held device 1 case is shaped as rectangular form. There is a push button 11 marked “Search”. The button 11, once pressed, initializes the search sequence. There are a group of direction indicators LED 18 on display module 16. Each direction indicator LED 18 represents a position or status of a searched object.

Refer to FIG. 5 which is a flowchart of decision making that instructs the base station 2 to determine location information based on the received directional signals. The location information causes direction indicators 18 on display module 16 to light up in direction of base station 2.

1. A method of tracking a location of an object, person or animal including the technique of determining the location of an object, person or animal and indicating the location of an object, person or animal based on the location information received in hand-held device.

2. A method as recited forth in claim 1, wherein said hand-held device generates a directional signal which represents a particular direction and transmits the said signal to the base station located at an object, person or animals.

3. A method as recited forth in claim 2, wherein said directional signal representing a particular direction is sent to the corresponding directional antenna respectively for later propagation. The directional antennas radiate the corresponding directional signal in a particular direction, covering the area where the base station is located.

4. A method as recited forth in claim 2, wherein said base station receives the said directional signal and computes the said directional signal to determine the base station location with respect to the hand-held location, and then transmits the location information to the hand-held device.

5. A method as recited forth in claim 1, wherein said hand-held device receives the said location information transmitted by base station and indicates the location of an object, person or animal on a display module.

6. A system of indicating location of an object, person or animal comprising: hand-held device means for generating and transmitting a directional signal which represents a particular direction; and directional antenna means for radiating the corresponding directional signal in a particular direction respectively; and a base station means for transmitting the computed location information to the said hand-held device.

7. A system as recited forth in claim 6, wherein said base station determines its location with respect to the hand-held location based on the said directional signal emitted by the said hand-held device.

8. A system as recited forth in claim 6, wherein said hand-held device receives the said location information and indicates a location of an object, person or animal by using LED, LCD, graph, or voice module.
